(19) United States
(12) Patent Application Publication
(10) Pub. No.: US 2008/0215978 A1
(43) Pub. Date: Sep. 4, 2008

(54) DISPLAY PROCESSING DEVICE, DISPLAY PROCESSING METHOD, AND DISPLAY PROCESSING PROGRAM

(76) Inventor: Akiko Bamba, Tokyo (JP)

Correspondence Address: DICKSTEIN SHAPIRO LLP, 1825 EYE STREET NW, Washington, DC, 20006-5403, US

(21) Appl. No.: 12/030,471

(22) Filed: Feb. 13, 2008

(30) Foreign Application Priority Data
Mar. 2, 2007 (JP) 2007-052885

(51) Int. Cl. G06F 3/00

(52) U.S. Cl. 715/713

(57) ABSTRACT

A selection screen is displayed on an operation panel. The selection screen contains a plurality of menu icons each corresponding to an instruction arranged in an arch shape. When a user selects one menu icon at the selection screen, a selection screen after change is displayed. In the selection screen after change, the selected menu icon is displayed on a certain position and non-selected menu icons are displayed while maintaining their positional relation with the selected menu icons.

### CROSS-REFERENCE TO RELATED APPLICATIONS

The present application claims priority to and incorporates by reference the entire contents of Japanese priority document, 2007-052885 filed in Japan on Mar. 2, 2007.

### BACKGROUND OF THE INVENTION

1. Field of the Invention

The present invention relates to technology for displaying a selection screen for setting and performing functions.

2. Description of the Related Art

In recent years, so called multi function peripherals (MFP's), having functions of a printer, a copier, a facsimile, and a scanner bundled together have become popular. A typical MFP is provided with a displaying unit, a printing unit, and an image-pickup unit, and other units in one cabinet and is also provided with pieces of software corresponding thereto. By switching these pieces of software, the apparatus can be operated as a printer, copier, scanner, or facsimile apparatus.

In conventional MFPs, for setting various functions mentioned above for execution, a display operating unit, such as a liquid crystal panel, is provided. In recent MFPs, with a plurality of functions and many items to be set, there is a need for displaying an easy-to-understand setting screen (selection screen) and reducing setting operation loads on users.

To satisfy this need, a method has been developed, for example, in which, instead of displaying all setting items of the functions on one screen, switching is made among function setting screens by selecting a predetermined button or tab. For example, Japanese Patent Application Laid-open Publication No. 2000-227849, FIG. 17, discloses the following technology: setting items shaped like indexes of a loose-leaf notebook are provided for respective function setting screens and, upon selection of one of the setting items, the setting screen of the selected setting item is displayed on top, thereby allowing settings of the item under various conditions. Upon selection of another one of the setting items, the setting screen of the other selected setting item is displayed on top, thereby allowing settings of the item under various conditions.

However, in the display method disclosed in the above patent gazette, the setting items of each function setting screen are displayed in the same size and horizontally aligned in a row. Therefore, these setting items are analogous and difficult to read. Moreover, it is difficult to understand at a glance which setting item is being selected now. Furthermore, when the setting items on the setting screen cannot be displayed in one horizontal row, they will be displayed in a plurality of vertically-aligned rows. In such a case, when a lower setting item is displayed and then an upper setting item is displayed, a setting screen of the upper setting item is displayed on top, and the upper setting item and the lower setting item change places. Therefore, it is difficult to understand which setting item is being set so far or where the setting item to be set next is located.

### SUMMARY OF THE INVENTION

It is an object of the present invention to at least partially solve the problems in the conventional technology.

According to an aspect of the present invention, there is provided a display processing device that includes a display processing unit that displays on a displaying unit a selection screen having disposed thereon in an arc shape a plurality of upper-level-item symbols that correspond to a plurality of upper-level setting items for instruction of selection of the upper-level setting items; and a selection accepting unit that accepts a selection of an upper-level-item symbol from among the upper-level-item symbols by a user. The display processing unit displays on the displaying unit a selection screen after change in which the selected upper-level-item symbol is arranged at a predetermined position indicative of being selected and in which non-selected upper-level-item symbol are arranged so as to maintain a positional relation with the selected upper-level-item symbol.

According to another aspect of the present invention, there is provided a display method including first displaying including displaying on a displaying unit a selection screen having disposed thereon in an arc shape a plurality of upper-level-item symbols that correspond to a plurality of upper-level setting items for instruction of selection of the upper-level setting items; accepting a selection of an upper-level-item symbol from among the upper-level-item symbols by a user; and second displaying including displaying on the displaying unit a selection screen after change in which the selected upper-level-item symbol is arranged at a predetermined position indicative of being selected and in which non-selected upper-level-item symbol are arranged so as to maintain a positional relation with the selected upper-level-item symbol.

According to another aspect of the present invention, there is provided a computer program product containing a computer program that causes a computer to implement the above displaying method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of an MFP capable of executing functions of a display processing device according to a first embodiment of the present invention;

FIG. 2 is a drawing of one example of an operation panel of the MFP;

FIG. 3 is a schematic diagram of one example of a Home screen, which is a selection screen;

FIG. 4 is a drawing of another example of the selection screen displayed on the MFP;

FIG. 5 is a drawing of one example of a switching screen;

FIG. 6 is a drawing for explaining a relation between menu icons prepared in advance and a menu icon to be selected;

FIG. 7 is a drawing of another example of the selection screen displayed on the MFP;

FIG. 8 is a drawing of still another example of the selection screen displayed on the MFP;

FIG. 9 is a flowchart of an entire flow of a display process in the first embodiment;

FIG. 10 is a schematic drawing of one example of a Home screen, which is a selection screen;

FIG. 11 is a flowchart of an entire flow of a display process in a second embodiment;

FIG. 12 is a schematic drawing of one example of the Home screen, which is a selection screen;

FIG. 13 is a schematic drawing of one example of the Home screen, which is a selection screen;

FIG. 14 is a schematic drawing of one example of the Home screen, which is a selection screen; and

FIG. 15 is a block drawing of hardware configuration of an MFP according to the first and second embodiments.

### DETAILED DESCRIPTION OF THE PREFERRED EMBODIMENTS

Exemplary embodiments of the present invention are explained in detail below. In the following embodiments, the case is explained in which the display processing device is applied to an MFP having a plurality of functions, such as a copier, facsimile, and printer, accommodated in one cabinet.

The display processing device according to the first embodiment displays a selection screen that includes a plurality of menu icons arranged in an arc shape and. When a menu icon is selected from the selection screen, the selection menu is changed to a selection screen after change in which the selected menu icon is displayed at a predetermined position. The selection screen after change refers to a selection screen that is displayed when any one of the menu icons is selected.

Icons represent various pieces of data and processing functions displayed as pictures and pictograms on a screen for display. Menu icons each correspond to a menu item, which is a function item of the device, allowing instruction of selection of each menu item. Although icons are displayed on a screen in the present embodiment, this is not meant to be restrictive. Alternatively, symbols including icons and representations of various pieces of data and processing functions as signs, character strings, and others may be displayed.

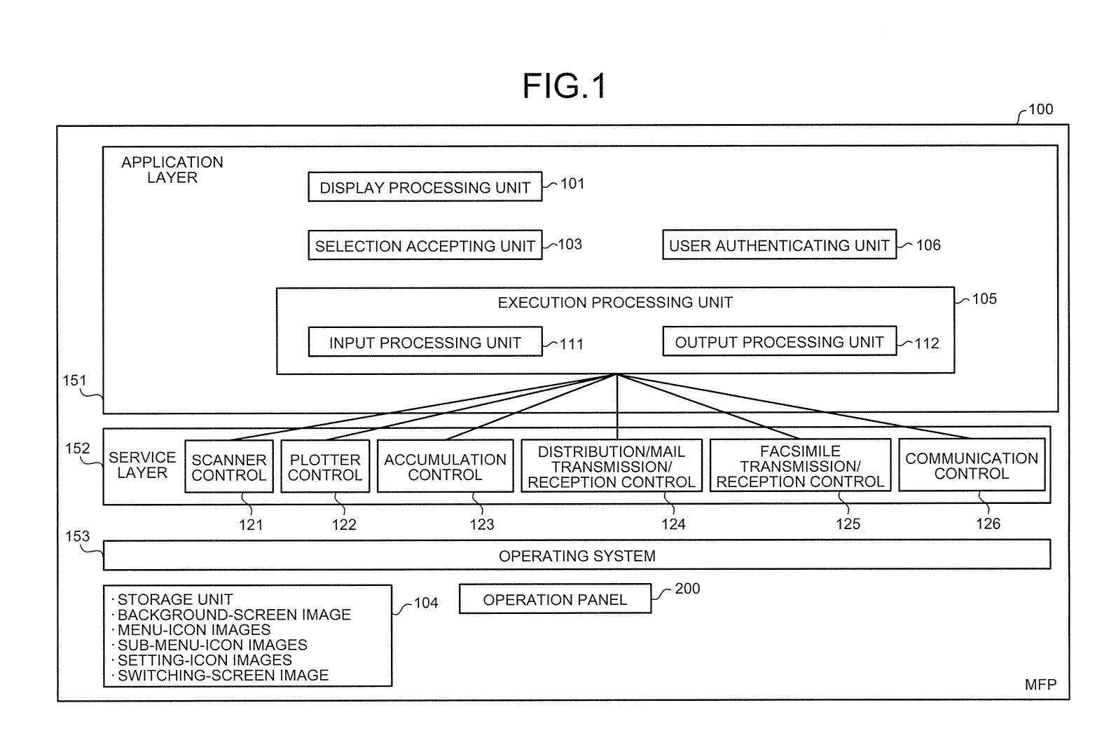

FIG. 1 is a functional block diagram of an MFP 100 capable of executing functions of a display processing device according to the first embodiment of the present invention. The MFP 100 an operating system 153, a service layer 152, an application layer 151, a storage unit 104, and an operation panel 200.

The functions of the MFP 100 are in a hierarchical relation, in which the operating system 153 has constructed on its upper layer the service layer 152, and the service layer 152 has constructed on its upper layer the application layer 151 including features of the present embodiment, which will be explained below.

The operating system 153 manages resources of the MFP 100 including hardware resources, and provides the service layer 152 and the application layer 151 with functions achieved by using the resources.

The service layer 152 corresponds to drivers that control the hardware resources included in the MFP 100. In response to a request in an output process from an execution processing unit 105, which will be explained further below, included in the application layer 151, the hardware recourses included in the MFP 100 are controlled from, for example, a scanner controlling unit 121, a plotter controlling unit 122, an accumulation controlling unit 123, a distribution/mail transmission/reception controlling unit 124, a FAX transmission/reception controlling unit 125, and a communication controlling unit 126, thereby causing various functions to be executed.

The storage unit 104 stores image data read from a paper document or received via e-mail or facsimile. Also, the storage unit 104 stores icon images such as menu icons, sub-menu icons, and setting icons as images for display on the operation panel 200 (which will be explained further below).

A sub-menu icon is a lower-level-item icon for instruction of selection of a sub-menu item, which is a lower-level item of a menu item, and is stored in the storage unit 104 in association with the menu item to which the sub-menu item belongs. Association may be such that, for example, a table in which a file name of a menu icon and a file name of a sub-menu icon are associated with each other is held.

A setting icon is a lower-level-item icon for instruction of selection of a settable lower-level setting item of a menu item or a sub-menu item, and is stored in the storage unit 104 in association with the menu icon of the menu item to which the setting item belongs or the sub-menu icon of the sub-menu item to which setting item belongs. Association may be such that, for example, a table in which a file name of a menu icon or a sub-menu icon and a file name of a setting icon are associated with each other is held.

Also, the storage unit 104 stores, as explained above, an image of a background screen (hereinafter, “background-screen image”, which will be explained further below) in which the menu icons, the sub-menu icons, and the setting icons can be disposed and an image of a switching screen (hereinafter, “switching-screen image”, which will be explained further below) virtually displaying a state in which the menu icons rotate in an arc shape.

Here, the storage unit 104 is a storage unit that can store data, such as image data, and can be configured of any storage medium generally used, for example, a Hard Disk Drive (HDD), an optical disk, or a memory card.

The operation panel 200 is a user interface that displays a selection screen and receives input on the selection screen.

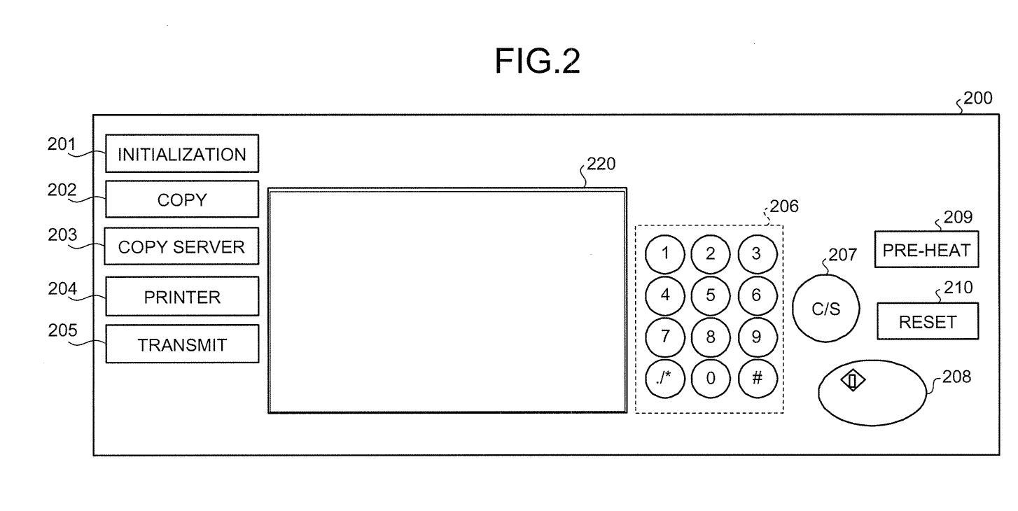

FIG. 2 is a drawing of one example of the operation panel of the MFP. As depicted in FIG. 2, the operation panel 200 includes an initialization key 201, a copy key 202, a copy server key 203, a printer key 204, a transmission key 205, a numerical keypad 206, a clear/stop key 207, a start key 208, a pre-heat key 209, a reset key 210, and a liquid-crystal touch panel 220. On the liquid-crystal touch panel 220, a screen, which is a feature of the present embodiment, is to be displayed, and this screen will be explained further below. Also, inside the operation panel 200, a Central Processing Unit (CPU) for controlling display of various screen onto the liquid-crystal touch panel 220 and controlling key inputs from the respective keys or the liquid-crystal touch panel 220 is provided separately from a CPU of the MFP body. This CPU of the operation panel 200 performs screen-display control and key-input control only, and therefore has a capability lower than the capability of the MFP body.

The MFP 100 includes, in addition to the storage unit 104 and the operation panel 200, various hardware resources such as a scanner and plotter, which are explained further below.

Referring back to FIG. 1, the application layer 151 includes a display processing unit 101, a selection accepting unit 103, the execution processing unit 105, and a user authenticating unit 106.

The user authenticating unit 106 authenticates a user when using the MFP 100. Any user authentication method can be used irrespectively of whether the method is known to those skilled in the art. If user authentication has been successful at the user authenticating unit 106, the use of a predetermined function can be permitted at the MFP 100. An example of the permitted function is transmission and reception of an electronic mail, for example. Also, it is assumed that user authentication at the user authenticating unit 106 is performed first and, in principle, user authentication has already been finished when a process explained further below is performed.

The display processing unit 101 causes, for example, a selection screen for executing various functions and selecting and setting a setting item to be displayed. In the present embodiment, display switching is performed in which the selection screen with menu icons being disposed in an arc shape is displayed to change a menu icon selected by the selection accepting unit 103 to a defined position, and a selection screen after change obtained by changing the menu icons other than the selected menu icon while keeping a positional relation with the selected menu icon is displayed. Here, the arc shape may be a curve that gives a sense of rotation, such as a curve, a parabola, part of a perfect circle, or part of an ellipse. In the present embodiment, the arc shape is part of an ellipse. With this, an area required for display can be reduced while giving a sense of rotation. Also, “change the menu icon to a defined position” means that a change is made in a manner such that, when any of the menu icons disposed in an arc shape is selected, the selected menu icon is moved in an arc shape to be disposed at a predetermined position, or a selection screen after change is displayed in which the selected menu icon is disposed at the defined position. With this, the selected menu icon is visually recognized as being moved along the curve of the arc shape. Furthermore, the display processing unit 101 causes sub-menu icons of sub-menu items belonging to the menu item of the selected menu icon on a lower portion of the area where the menu icons are disposed. This is preferable in implying a parent-child relation (superordinate concept and subordinate concept) in which the contents of the menu icons represent parent contents (superordinate concept) whilst the contents of the menu icons and the setting icons represent child contents (subordinate concept).

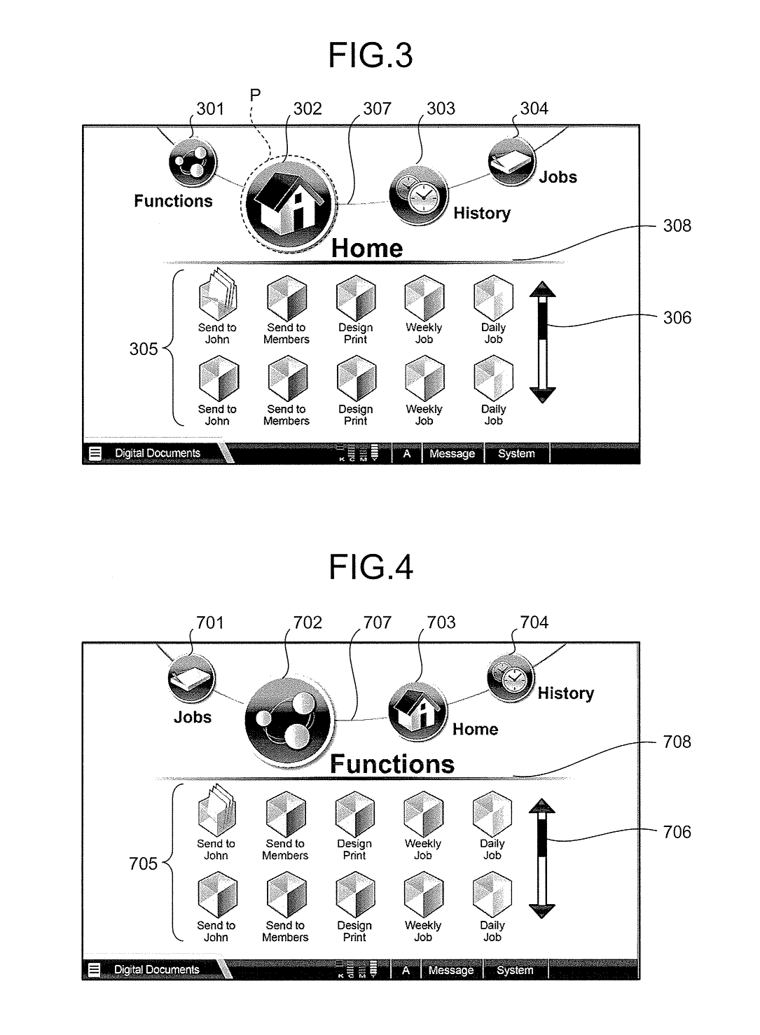

FIG. 3 is a schematic diagram of one example of a Home screen, which is a selection screen. The Home screen is a selection screen on which, when user authentication by the user authenticating unit 106 is successful, menu icons unique to the user are displayed.

Here, the selection screen having disposed thereon the selected menu icon and others is explained. In the present embodiment, it is assumed that four menu icons are provided, that is, a “Home” menu icon for displaying a Home screen, a “Jobs” menu icon for displaying a Jobs screen, a “Functions” menu icon for displaying a Functions screen, and a “History” menu icon for displaying a History screen.

As depicted in FIG. 3, the Home screen displayed on the liquid-crystal touch panel 220 has disposed thereon a straight-line linear image 307 in an arc shape. On that linear image, menu icons 301, 302, 303, and 304 are disposed. With this, the menu icons 301, 302, 303, and 304 are disposed in an arc shape. With the “Home” menu icon 302 being displayed as enlarged compared with the other menu icons and displayed at a defined position, it is indicated that the “Home” menu icon 302 has been selected.

Here, the defined position is a position indicating that a menu icon is selected. Specifically, a position P leftward from the center of an upper portion of the screen in FIG. 3 and second from the left-end menu icon serves as the defined position. The display processing unit 101 changes the selected menu icon so that any selected menu icon is disposed at that defined position P even if any menu icon is selected. Also, the display processing unit 101 causes the menu icons other than the selected menu icon displayed on the liquid-crystal touch panel 220 to be changed while keeping a positional relation with the selected menu icon. That is, a change is made along the arc-shaped linear image 307 while the arrangement order of the menu icons is kept. Here, the linear image 307 is an image of an arc-shaped curve indicating positions where a plurality of menu icons are disposed in an arc shape. This linear image can be represented by, for example, a straight line, a dotted line, or a collection of dots, so as to allow the menu icons to be disposed in an arc shape. Although the linear image is represented by an image of a straight line in the present embodiment, this is not meant to be restrictive.

Also, on the Home screen (selection screen), disposed below the menu icons 301, 302, 303, and 304 is a solid-line boundary image 308, and disposed further below is a group of sub-menu icons 305 in a lattice shape, the group including sub-menu icons and setting icons corresponding to the “Home” menu icon. Here, the boundary image 308 is a straight-line image indicating a boundary between the menu icons and the sub-menu icons and setting icons. The boundary image can be represented by, for example, a straight line, a dotted line, or a collection of dots, so as to allow the boundary between the menu icons and the sub-menu icons to be displayed. In the present embodiment, the boundary image is represented by a solid line, thereby making it easy to recognize that the area of the menu icons and the area of the sub-menu icons are separated from each other. Also, the area where the menu icons are disposed and the area where the sub-menu icons and setting icons are disposed may have different colors, thereby indicating the boundary between the menu icons and the sub-menu icons or the setting icons. For example, the area having the menu icons disposed thereon has a background color of red, whilst the area having the sub-menu icons and setting icons disposed thereon has a background color of blue.

On the right side of the group of sub-menu icons 305, a scroll bar 306 is displayed, thereby allowing sub-menu icons and setting icons that have not yet been able to be displayed on the liquid-crystal touch panel 220 to be displayed by scrolling.

For example, in this Home screen of FIG. 3, when the menu icon 301 corresponding to the menu item “Functions” is selected by the user, a selection screen (selection screen after change) depicted in FIG. 4 is displayed on the liquid-crystal touch panel 220.

FIG. 4 is a drawing of another example of the selection screen displayed on the MFP. In FIG. 4, as depicted in FIG. 4, the liquid-crystal touch panel 220 has disposed thereon a solid-line linear image 707 in an arc shape. On this linear image, menu icons 701, 702, 703, and 704 are disposed. With this, the “Functions” menu icon 702 is displayed at a defined position as being enlarged other than the other menu icons, thereby indicating that the “Functions” menu icon 702 has been selected. With the “Functions” menu icon 702 being selected, each menu icon is changed so as to be disposed as being shifted by one icon in a counterclockwise direction. Therefore, the arrangement is such that the “Jobs” menu icon that has been located at the right end (at the position of 704) is changed to the left end (at the position of 701), the “History” menu icon that has been located at a position second from the right end (at the position of 703) is changed to the right end, and the “Home” menu icon that has been located at the defined position (at the position of 702) is changed to a position second from the right end. Also, on the selection screen, disposed below the menu icons 701, 702, 703, and 704 is a solid-line boundary image 708, and disposed further below is a group of sub-menu icons 705 in a lattice shape, the group including sub-menu icons and setting icons corresponding to the “Functions” menu icons. On the right side of the sub-menu icon group 705, a scroll bar 706 is disposed.

Here, when the selection screen is switched, the display processing unit 101 once causes a switching screen to be displayed, and then immediately causes a selection screen to be displayed, the selection screen having the selected menu icon displayed thereon. The switching screen is a screen where it looks as if the selected menu icon and other menu icons were rotated and moved in an arc shape when the menu icon is selected.

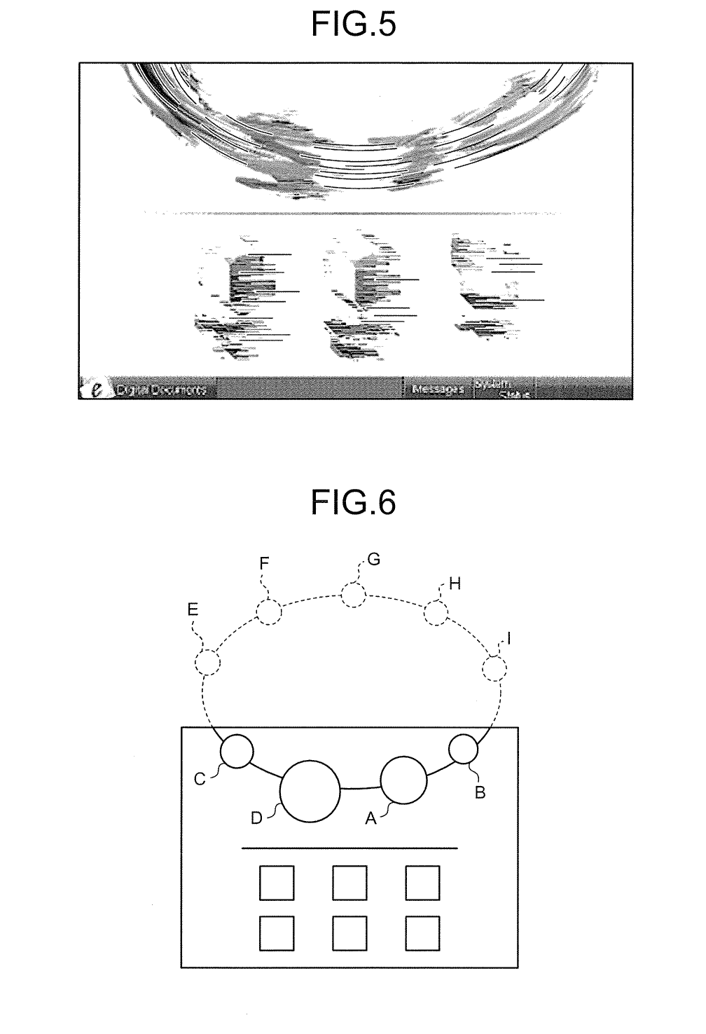

FIG. 5 is a drawing of one example of a switching screen. As depicted in FIG. 5, an arc-shaped figure is disposed on an upper portion of the switching screen, indicating a state in which the menu icons are moving and rotating. On a lower portion of the switching screen, a figure is disposed, indicating a state in which the sub-menu icons and the setting icons horizontally move. After once display this switching screen, a selection screen after change is displayed in which the selected menu icon is disposed at the defined position. With this, the menu icons can be displayed as rotating in an arc shape, and the load that is supposed to be required for a display operation when these icons are actually rotated can be reduced.

Here, when the selected menu icon is changed, the other menu icons are also changed accordingly. Since only a predetermined number (display number) of menu icons can be disposed on the selection screen, part of the menu icons on the selection screen is deleted and is replaced by new ones on the selection screen according to the change. That is, although the menu icons are stored and prepared in the storage unit 104 as many as the number of setting items of the menu, since only the display number of menu icons are displayed on the selection screen, there are icons to be deleted from the selection screen and icons to appear on the selection screen according to the change of the menu icons in association with the selection.

FIG. 6 is a drawing for explaining a relation between menu icons prepared in advance and a menu icon to be selected. In FIG. 6, an exemplary case is depicted in which the number of menu icons prepared in advance is nine and the number of display is four. As depicted in FIG. 6, suppose that all of the menu icons prepared in advance are internally disposed in the display order along the arc of the ellipse. Also suppose that five menu icons (E, F, G, H, and I) other than four menu icons (A, B, C, and D) displayed on the selection screen are internally disposed along an arc at the back of the selection screen (an arc represented by a dotted line). When a desired icon is selected from out of the menu icons displayed, the selected menu icon is changed to the defined position, and the other menu icons are changed accordingly. As a result, according to the change, part of the displayed menu icons is deleted from the selection screen as being moved on an arc represented by a dotted line at the back of the selection screen. On the other hand, of the menu icons on the arc represented by the dotted line at the back of the selection screen, menu icons as many as the menu icons deleted according to the display order newly appear on the selection screen.

For example, in FIG. 6, consider the case where a menu icon B is selected. In this case, the menu icon B is changed to the defined position (a position of a menu icon D in FIG. 6). According to the change, all icons rotate in a clockwise direction. As a result, menu icons I and H newly appear on the right side, and menu icons C and D are deleted from the selection screen to be moved to the arc represented by the dotted line. Here, in FIG. 6, four menu icons are display on the selection screen, but the number of menu icons to be displayed may be more or less. Also, when five or more menu icons are displayed, as the number of menu icons to be displayed is larger, the size of each menu icon may be smaller or may be similar to that as in FIG. 6. If each menu icon is displayed with its size similar to that as in FIG. 6, the menu icon is easy to view and easy to operate, and therefore this is preferable. Here, when it is considered that menu icons not appearing on the selection screen are on the arc represented by the dotted line in FIG. 6, the explanation above corresponds to the following: when menu icons not appearing on the selection screen are added thereto, the size of each of these menu icons appearing on the selection screen is reduced according to the number of menu icons not appearing on the selection screen or is unchanged.

The display processing unit 101 performs display and switching of the selection screen as explained above and, specifically, performs the following process. When the selection screen is displayed on the liquid-crystal touch panel 220, with user authentication by the user authenticating unit 106 being successfully, the Home screen is first displayed (refer to FIG. 3). That is, the display processing unit 101 reads menu-icon images, a background-screen image, and sub-menu-icon images and setting-icon images corresponding to the “Home” menu icons. Here, the background-screen image represents a screen in a state where the menu icons and the sub-menu icons are deleted from the selection screen. That is, the background-screen image is a screen image where only the arc-shaped linear image 307 and the boundary image 308 are rendered.

The display processing unit 101 causes the read “Home” menu icon to be disposed at the defined position, causes the menu icons including the “Home” menu icon to be disposed in an arc shape on the upper portion of the background screen, and also causes the read sub-menu icons and setting icons to be disposed in a lattice shape on the lower portion of the background screen below the menu icons on the background screen and below the boundary image, thereby generating a selection screen. The generated selection screen is displayed on the liquid-crystal touch panel 220. In this manner, with the sub-menu icons and other being disposed below the menu icons, it can be implied that the relation between the items corresponding to these icons is such that they are a superordinate concept and a subordinate concept. Also, when the icons are disposed in a lattice shape, for example, they can be disposed in a lattice shape as being tilted at 45 degrees, they can be disposed in a checked pattern, or they can be disposed in a horizontal-vertical lattice shape. In the present embodiment, they are disposed in a horizontal-vertical lattice shape. With this, the icons can be displayed with a simple outer appearance, and also the area required for display can be reduced.

Here, the display processing unit 101 causes the menu icon to be disposed at the defined position upon acceptance of selection, in this case, the “Home” icon, to be enlarged to a size allowing recognition at a glance compared to the other menu icons, and disposed and displayed on the liquid-crystal touch panel 220. Also, the menu icons other than the selected menu icon may be all displayed with a constant size, or may be displayed in a manner such that they are gradually reduced in size as they are farther away from the selected menu icon.

When a selection of a menu icon is accepted from the user by the selection accepting unit 103 (which will be explained further below), the display processing unit 101 reads a switching-screen image from the storage unit 104, and causes the read switching-screen image to be displayed on the liquid-crystal touch panel 220.

After the switching-screen image is displayed, the display processing unit 101 causes the menu icons to be disposed as being changed so that the selected menu icon is disposed at the defined position. That is, the display processing unit 101 causes the selected menu icon to be disposed at the defined position on the background screen. With this, for example, when the menu icons are disposed as being rotated in a clockwise direction, menu icons not yet displayed are read from the storage unit 104 onto the liquid-crystal touch panel 220 and are newly disposed on a right-end portion of the arc on the background screen, and the menu icons disposed before changed are changed in a clockwise direction. Furthermore, the menu icons that have been displayed on the liquid-crystal touch panel 220 on a left-end portion of the arc are deleted.

Still further, the display processing unit 101 causes the sub-menu icons and setting icons corresponding to the selected and read menu icon to be disposed in a lattice shape below the menu icons on the background screen. The display processing unit 101 then causes the background screen having disposed thereon the menu icons, the sub-menu icons, and the setting icons to be displayed as a selection screen on the liquid-crystal touch panel 220.

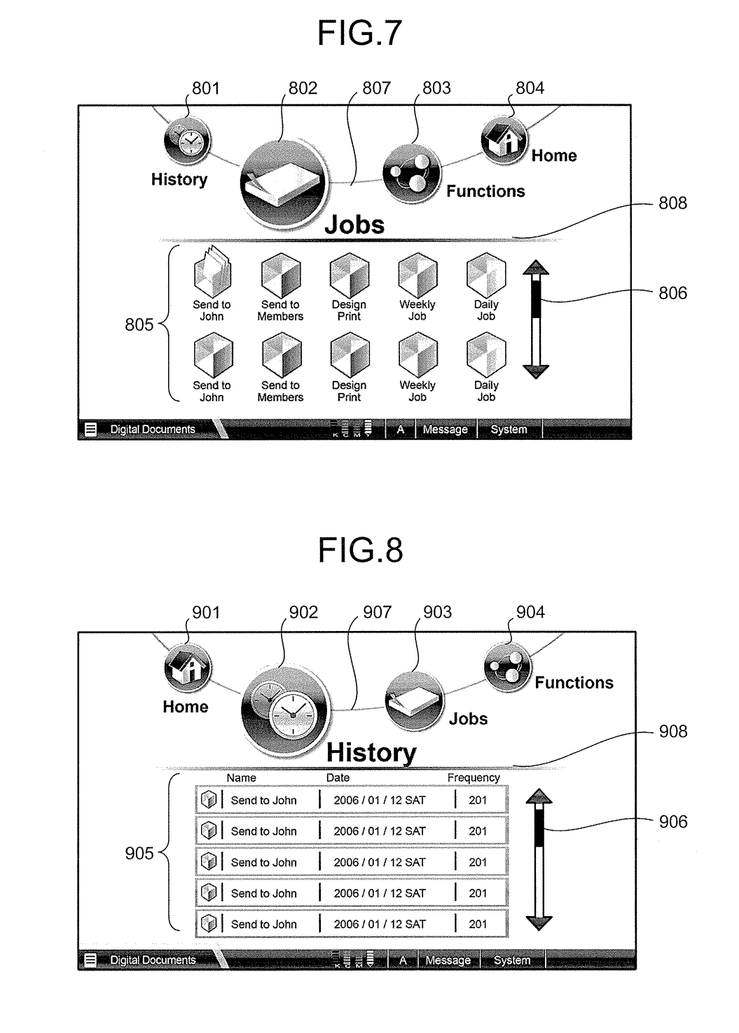

A selection screen when another menu icon is selected is now explained. FIG. 7 is a drawing of another example of the selection screen displayed on the MFP. FIG. 7 depicts the case where the “Jobs” menu icon is selected in the “Home” screen in FIG. 3. As depicted in FIG. 7, the liquid-crystal touch panel 220 has a solid-line linear image 807 in an arc shape disposed on the background screen. On that linear image, menu icons 801, 802, 803, and 804 are disposed and displayed in an arc shape. Then, with the “Jobs” menu icon 802 being enlarged more than the other menu icons and displayed at the defined position, it is indicated that the “Jobs” menu icon 802 has been selected. With the “Jobs” menu icon being selected, the menu icons are changed so as to be moved by two icons in a clockwise direction for disposition. Therefore, the “History” menu icon that has been located at a position second from the right end (at the position of 803) is changed to the left end (at the position of 801), the “Home” menu icon that has been located at the defined position (at the position of 802) is changed to the right end (at the position of 804), and the “Functions” menu icon that has been located at the left end is changed to at a position second from the right end. Also, on the selection screen, disposed below the menu icons 801, 802, 803, and 804 is a solid-line boundary image 808, and disposed further below is a group of sub-menu icons 805 in a lattice shape, the group including sub-menu icons and setting icons corresponding to the “Jobs” menu icons. On the right side of the sub-menu icon group 805, a scroll bar 806 is disposed.

A selection screen when still another menu icon is selected is now explained. FIG. 8 is a drawing of still another example of the selection screen displayed on the MFP. FIG. 8 depicts the case where the “History” menu icon is selected in the “Home” screen in FIG. 3. As depicted in FIG. 8, the liquid-crystal touch panel 220 has a solid-line linear image 907 in an arc shape disposed on the background screen. On that linear image, menu icons 901, 902, 903, and 904 are disposed and displayed in an arc shape. Then, with the “History” menu icon 902 being enlarged more than the other menu icons and displayed at the defined position, it is indicated that the “History” menu icon 902 has been selected. With the “History” menu icon being selected, the menu icons are changed so as to be moved by one icon in a clockwise direction for disposition. Therefore, the “Home” menu icon that has been located at the defined position (at the position of 902) is changed to the left end (at the position of 901), the “Functions” menu icon that has been located at the left end is changed to the right end (at the position of 904), and the “Job” menu icon that has been located at the right end is changed to a position second from the right end (at the position of 903). Also, on the selection screen, disposed below the menu icons 901, 902, 903, and 904 is a solid-line boundary image 908, and disposed further below is a history (sub-menu icons) 905 of the MFP 100 corresponding to the “History” menu icons. On the right side of the history 905, a scroll bar 906 is disposed.

Also, when successive instruction operations are accepted by the selection accepting unit 103 (which will be explained further below), the display processing unit 101 successively switches the selection screen in a manner as if the menu icons move in a clockwise or counterclockwise direction for display on the liquid-crystal touch panel 220. For example, when the user performs touch inputs on a menu icon or a position nearby continuously for a predetermined time, such inputs are accepted as successive instructions, and display switching from the selection screen to the switching screen and then to another selection screen is successively performed, thereby producing a display in a manner as if the menu icons move in a clockwise or counterclockwise direction.

The selection accepting unit 103 accepts a selection of a menu icon of a user-desired menu from out of the menu icons on the selection screen caused to be displayed by the display processing unit 101. Specifically, when a menu item caused to be displayed by the display processing unit 101 on the liquid-crystal touch panel 220 is pressed by the user, the selection accepting unit 103 accepts such an input as the pressed menu item being selected. Also, the selection accepting unit 103 accepts inputs from various buttons, such as the initialization key 201.

Furthermore, when a menu icon or a position nearby is continuously pressed by the user, the selection accepting unit 103 accepts such an input as an instruction operation for successively switching the selection screen in a manner as if the menu icons move in a predetermined direction (for example, a clockwise direction). Alternatively, when a menu icon or a position nearby is dragged in a clockwise direction by the user, the selection accepting unit 103 accepts such an input as an instruction operation for successively switching the selection screen in a manner as if the menu icons move in a clockwise direction. When a menu icon or a position nearby is dragged in a counterclockwise direction by the user, the selection accepting unit 103 accepts such an input as an instruction operation for successively switching the selection screen in a manner as if the menu icons move in a counterclockwise direction. Here, dragging means that any position on the liquid-crystal touch panel 220 is moved as being pressed with a user's finger or the like.

The execution processing unit 105 includes an input processing unit 111 and an output processing unit 112 for performing an input/output process using a function of the MFP 100. Based on the contents processed at the execution processing unit 105, each controlling unit included in the service layer 152 controls hardware resources, thereby performing a process using hardware.

The input processing unit 111 performs a process of inputting image data using an input function corresponding to a setting icon of the selected menu icon accepted by the selection accepting unit 103. For example, when the selection accepting unit 103 accepts a selection of a “Design Print” setting icon, the input processing unit 111 causes the scanner controlling unit 121 to control a scanner not shown, thereby reading a paper document.

The output processing unit 112 performs a process of outputting image data using an output function corresponding to a setting icon of the selected menu icon accepted by the selection accepting unit 103. For example, when the selection accepting unit 103 accepts a selection of a “Design Print” setting icon, the output processing unit 112 causes the plotter controlling unit 122 to control a plotter not shown, thereby controlling a printing process with a paper document.

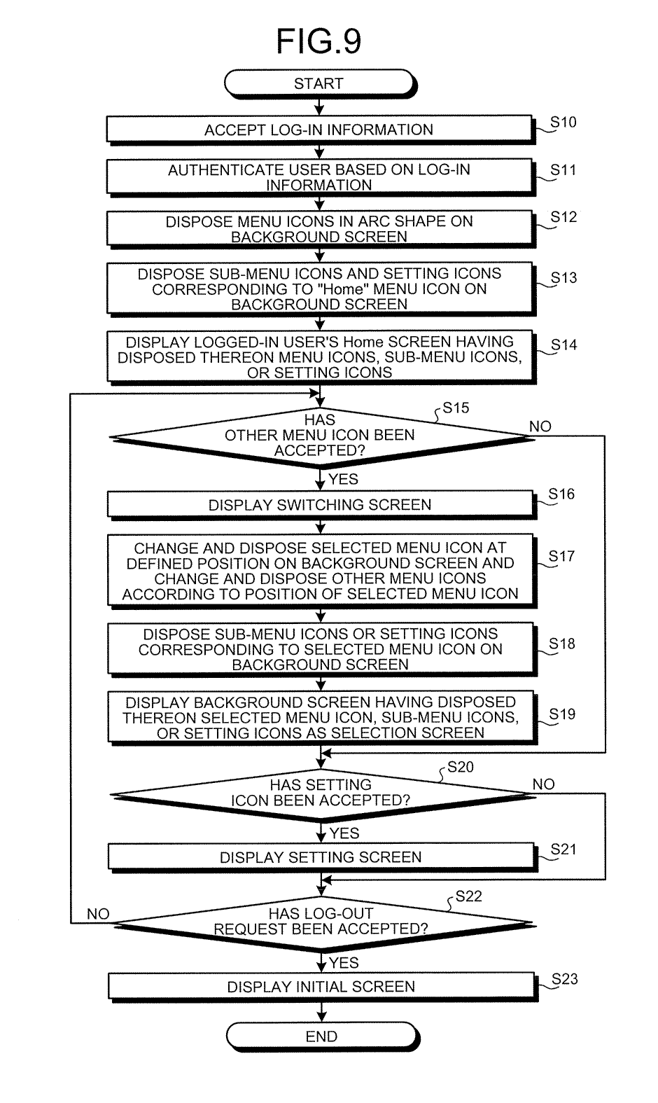

Next, a display process by the MFP 100 configured above according to the first embodiment is explained. FIG. 9 is a flowchart of an entire flow of a display process in the first embodiment.

First, the selection accepting unit 103 accepts log-in information entered by the user (step S10). Specifically, the selection accepting unit 103 accepts a user name and a password entered on a log-in screen as log-in information. The log-in screen is, for example, a screen when the user selects a button for log-in displayed on an initial screen.

Next, the user authenticating unit 106 performs a process of user authentication based on log-in information accepted by the selection accepting unit 103 (step S11). If user authentication has been successful, the display processing unit 101 reads, from the storage unit 104, the background-screen image, the menu-icon images, and the sub-menu-icon images and setting-icon images corresponding to the “Home” menu icon, so as to cause a Home screen for the user to be displayed. The display processing unit 101 then causes the menu icons to be disposed in an arc shape on the read background screen (step S12). The display processing unit 101 then causes the sub-menu icons and setting icons corresponding to the “Home” menu icon in a lattice shape below the menu icons on the background screen (step S13). The display processing unit 101 then causes a Home screen for the logged-in user to be displayed on the liquid-crystal touch panel 220 (step S14), the Home screen generated with the menu icons, the sub-menu icons, or the setting icons being disposed thereon. This Home screen is the one depicted in FIG. 3.

Next, the selection accepting unit 103 determines whether a selection of another menu icon has been accepted (step S15). Examples of a selection screen to be displayed based on another menu icon include a Jobs screen for displaying jobs (Jobs) in which a routine process is defined, a Functions screen for displaying individual functions (such as copy and facsimile transmission) of the MFP 100, and a History screen for displaying process history.

If a selection of another menu icon has been accepted (“Yes” at step S15), the display processing unit 101 causes the switching screen to be displayed on the liquid-crystal touch panel 220 (step S16). If no selection of another menu icon has been accepted (“No” at step S15), the procedure goes to a process at step S20 without displaying of the switching screen.

Next, the display processing unit 101 causes the selected menu icon to be changed and disposed at the defined position on the background screen and the other menu icons to be changed and disposed according to the position of the selected menu icon (step S17). The display processing unit 101 then reads from the storage unit 104 the sub-menu-icon images and setting-icon images corresponding to the selected menu icon. The display processing unit 101 then causes the sub-menu icons and setting items corresponding to the selected menu icon to dispose below the menu icons on the background screen (step S18). The display processing unit 101 then causes the resultant screen to be displayed as a selection screen on the liquid-crystal touch panel 220, the screen being generated by disposing the menu icons, the sub-menu icons, or the setting icons on the background screen (step S19). Examples of the selection screen displayed here (selection screen after change) include those depicted in FIGS. 4, 7, and 8.

Next, it is determined whether a selection of a setting icon has been accepted from the selection screen (step S20). If a selection of a setting icon has been accepted (“Yes” at step S20), the display processing unit 101 causes a setting screen corresponding to the setting icon to be displayed on the liquid-crystal touch panel 220 (step S21), and various settings are performed from the displayed setting screen. On the other hand, if a selection of a setting icon has not been accepted (“No” at step S20), the process at step S21 is not performed. The process at step S21 is not performed either if no setting icon is displayed on the selection screen caused to be displayed by the display processing unit 101.

Next, the selection accepting unit 103 determines whether a log-out request has been accepted (step S22). The log-out request is accepted when, for example, a button for log-out displayed on a lower portion of the screen is selected.

If no log-out request has been accepted (“No” at step S22), the procedure returns to the process of accepting a selection of another menu icon for repeating the process (step S15). If a log-out request has been accepted (“Yes” at step S22), the display processing unit 101 causes an initial screen before log-in to be displayed (step S23).

In this manner, in the first embodiment, a selection screen having a plurality of menu icons disposed in an arc shape is displayed and, if a selection of a menu icon has been accepted from the user, a selection screen after change is displayed on the liquid-crystal touch panel 220, the selection screen after change obtained by enlarging the selected menu icon and changing to the defined position and changing the other display menu icons to be an arc shape while keeping a positional relation with the selected menu icon. Below the selected menu icon, sub-menu icons and setting icons corresponding to the selected menu icon are displayed. Therefore, with the menu icons being disposed and changed to be in an arc shape, the contents of the menu icons displayed on the selection screen can be easy to recognize, and the position of a desired menu icon can be easily grasped. Also, with the sub-menu icons and setting icons corresponding to the selected menu icon being disposed in a lattice shape for display, operability of the setting process of setting various items can be improved.

In the first embodiment, a selection screen having a plurality of menu icons disposed in an arc shape is displayed and, if any one of menu icons is selected, a selection screen after change is displayed, the selection screen after change obtained by changing the selected menu icon to the defined position and changing the sub-menu icons and others corresponding to the selected menu icon below the menu icons. In a second embodiment, the sub-menu icons and others corresponding to each of the unselected menu icons are reduced in size and displayed near the unselected menu icons.

Since the configuration of the MFP according to the present embodiment is similar to that in the first embodiment, only the configuration with different functions from those in the first embodiment is explained with reference to FIG. 1.

The display processing unit 101 has a function of, in addition of the functions in the first embodiment, causing a selection screen to be displayed, the selection screen obtained by reducing the sub-menu icons and setting icons corresponding to the menu icons other than the selected menu icon and disposing the reduced icons near the respective menu icons.

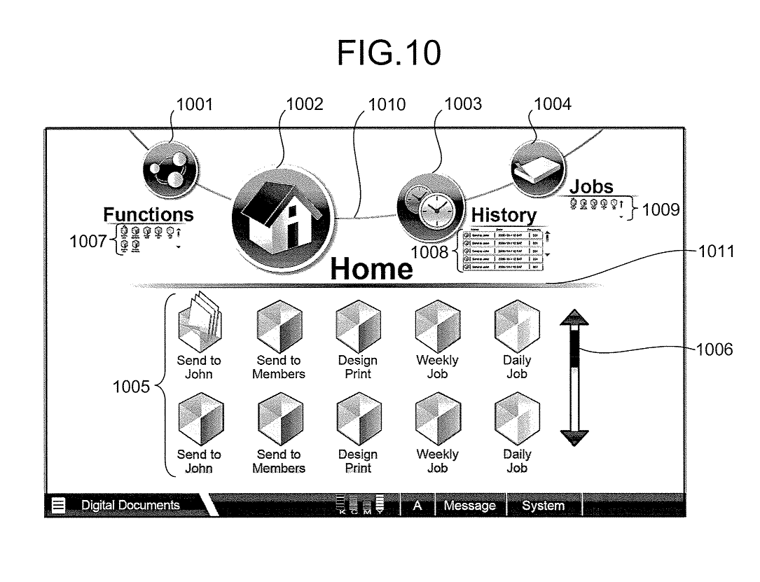

FIG. 10 is a schematic drawing of one example of a Home screen, which is a selection screen. As depicted in FIG. 10, the Home screen displayed on the liquid-crystal touch panel 220 has disposed thereon, as with FIG. 3, a solid-line linear image 1010 in an arc shape, on which menu icons 1001, 1002, 1003, and 1004 are disposed. With this, the menu icons 1001, 1002, 1003, and 1004 are displayed in an arc shape. With the “Home” menu icon 1002 being enlarged compared with the other menu icons and displayed at the defined position, it is indicated that the “Home” menu icon 1002 has been selected.

Also, on the Home screen (selection screen), disposed below the menu icons 1001, 1002, 1003, and 1004 is a solid-line boundary image 1011, and further below is a group of sub-menu icons 1005 in a lattice shape, the group including sub-menu icons and setting icons corresponding to the “Home” menu icons. On the right side of the group of sub-menu icons 1005, a scroll bar 1006 is displayed, thereby allowing sub-menu icons and setting icons that have not yet been able to be displayed on the liquid-crystal touch panel 220 to be displayed by scrolling.

Furthermore, in the second embodiment, groups of reduced sub-menu icons 1007, 1008, and 109 obtained by reducing sub-menu icons and setting icons corresponding to the menu icons other than the “Home” menu icon are disposed and displayed near the respective menu icons other than “Home”. In the second embodiment, when a menu icon is selected from the user, the display processing unit 101 causes such a selection screen to be switchably displayed. Here, at the time of switching the selection screen, as with the first embodiment, once a switching screen is displayed, and then the next selection screen (selection screen after change) is displayed.

Specifically, the display processing unit 101 performs the following processing. If user authentication by the user authenticating unit 106 has been successful, the display processing unit 101 reads from the storage unit 104 a menu-icon image, a background-screen image, sub-menu-icon images and setting-icon images corresponding to the “Home” menu icon, and sub-menu-icon images and setting-icon images corresponding to menu icons other than the “Home” to be displayed on the Home screen. The display processing unit 101 then causes the read “Home” menu icon at the defined position, and causes the menu icons including the “Home” menu icon to be disposed in an arc shape in an upper portion on the background screen, and causes the sub-menu-icons and setting-icons corresponding to the read “Home” menu icon to displayed in a lattice shape below the menu icons on the background screen and in a lower portion of the background screen below the boundary image.

Furthermore, the display processing unit 101 causes the sub-menu-icon images and setting-icon images corresponding to the menu icons other than the read “Home” to be reduced and disposed near the respective menu icons other than “Home”, thereby generating a selection screen. The generated selection screen is then displayed on the liquid-crystal touch panel 220. At this time, the display processing unit 101 causes the menu icon to be disposed at the defined position upon acceptance of selection, in this case, the “Home” icon, to be enlarged to a size allowing recognition at a glance compared to the other menu icons, and disposed and displayed on the liquid-crystal touch panel 220. Also, even when any one of the menu icons other than “Home” is selected, similarly, the respective sub-menu-icons and setting icons are reduced and displayed near the respective menu icons other than the selected menu icon.

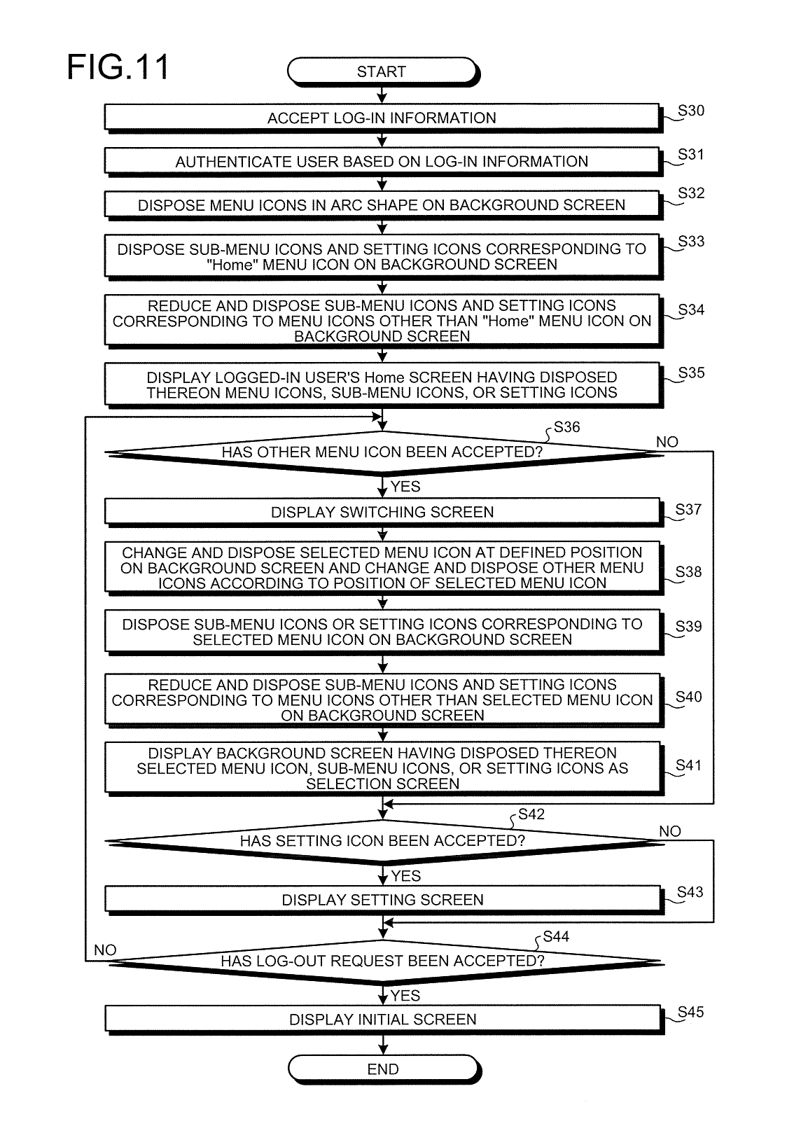

Next, a display process by the above-configured MFP 100 according to the second embodiment is explained. FIG. 11 is a flowchart of an entire flow of the display process in the second embodiment.

First, processes from acceptance of log-in information from the user to user authentication (steps S30 and S31) are similar to those of FIG. 9 in the first embodiment (step S10 and S11), and therefore are not explained herein.

If user authentication has been successful, the display processing unit 101 reads, from the storage unit 104, the background-screen image, the menu-icon images, the sub-menu-icon images and setting-icon images corresponding to the “Home” menu icon, and the sub-menu-icon images and setting-icon images corresponding to menu icons other than “Home”, so as to cause a Home screen for the user to be displayed. The display processing unit 101 then causes the menu icons to be disposed in an arc shape on the read background screen (step S32). The display processing unit 101 then causes the sub-menu icons and setting icons corresponding to the “Home” menu icon in a lattice shape below the menu icons on the background screen (step S33). The display processing unit 101 reduces the read sub-menu icons and setting icons corresponding to the menu icons other than the read “Home” and causes these icons to be disposed near the respective menu icons other than “Home” (step S34). The display processing unit 101 then causes a Home screen for the logged-in user to be displayed on the liquid-crystal touch panel 220 (step S35), the Home screen generated with the menu icons, the sub-menu icons, or the setting icons being disposed thereon. This Home screen is the one depicted in FIG. 10.

Next, the selection accepting unit 103 determines whether a selection of another menu icon has been accepted (step S36). If a selection of another menu icon has been accepted (“Yes” at step S36), the display processing unit 101 causes the switching screen to be displayed on the liquid-crystal touch panel 220 (step S37). If no selection of another menu icon has been accepted (“No” at step S36), the procedure goes to a process at step S42 without a display of the switching screen.

Next, the display processing unit 101 causes the selected menu icon to be changed and disposed at the defined position on the background screen and causes other menu icons to be changed and disposed according to the position of the selected menu icon (step S38). The display processing unit 101 then reads from the storage unit 104 the sub-menu-icons and setting-icons corresponding to the selected menu icon and the sub-menu-icons and setting-icons corresponding to the menu icons other than the selected menu icon. The display processing unit 101 causes the sub-menu-icon images and setting-icon images corresponding to the selected menu icon to be disposed below the menu icons on the background screen (step S39). Also, The display processing unit 101 causes the sub-menu-icon images and setting-icon images corresponding to the menu icons other than the read and selected menu icon to be reduced and disposed near the respective menu icons other than the selected menu icon (step S40). The display processing unit 101 then causes a selection screen to be displayed on the liquid-crystal touch panel 220, the selection screen generated by disposing the menu icons, the sub-menu icons, or the setting icons on the background screen (step S41).

Next, processes from selection of a setting icon to display of an initial screen (steps S42 to S45) are similar to those in FIG. 9 according to the first embodiment (step S20 to S23), and therefore are not explained herein.

In this manner, in the second embodiment, a selection screen is displayed in which a selection screen having a plurality of menu icons disposed in an arc shape is displayed and, if a selection of a menu icon has been accepted from the user, a selection screen after change is displayed on the liquid-crystal touch panel 220, the selection screen after change obtained by enlarging the selected menu icon and changing to the defined position and changing the other display menu icons to be an arc shape while keeping a positional relation with the selected menu icon. Below the selected menu icon, sub-menu icons and setting icons corresponding to the selected menu icon are displayed. Also, the sub-menu icons and setting icons corresponding to the unselected menu icons are reduced and displayed near the unselected menu icons. Therefore, with the menu icons being disposed and changed to be in an arc shape, the contents of the menu icons displayed on the selection screen can be easy to recognize, and the position of a desired menu icon can be easily grasped. Also, with the sub-menu icons and setting icons corresponding to the selected menu icon being disposed in a lattice shape for display, operability of the process of setting various items can be improved. Furthermore, the contents of the sub-menu icons and setting icons corresponding to the menu icons other than the selected menu icon are also displayed. Therefore, the sub-menu items and setting items in the unselected menu items can be easy to grasp, and operability can be further improved.

In the first and second embodiments, the display processing unit 101 performs a vertical display in which the menu icons are disposed on an upper portion and the sub-menu icons and others are disposed below the menu icons. However, this is not meant to be restrictive. For example, the display processing unit 101 may perform a horizontal display in which the menu icons are disposed on the left side and the sub-menu icons and others are disposed on the right side of the menu icons. Here, the configuration of the third embodiment is similar to the first embodiment except for the arrangement of the menu icons and the sub-menu icons and others, and therefore is not further explained herein.

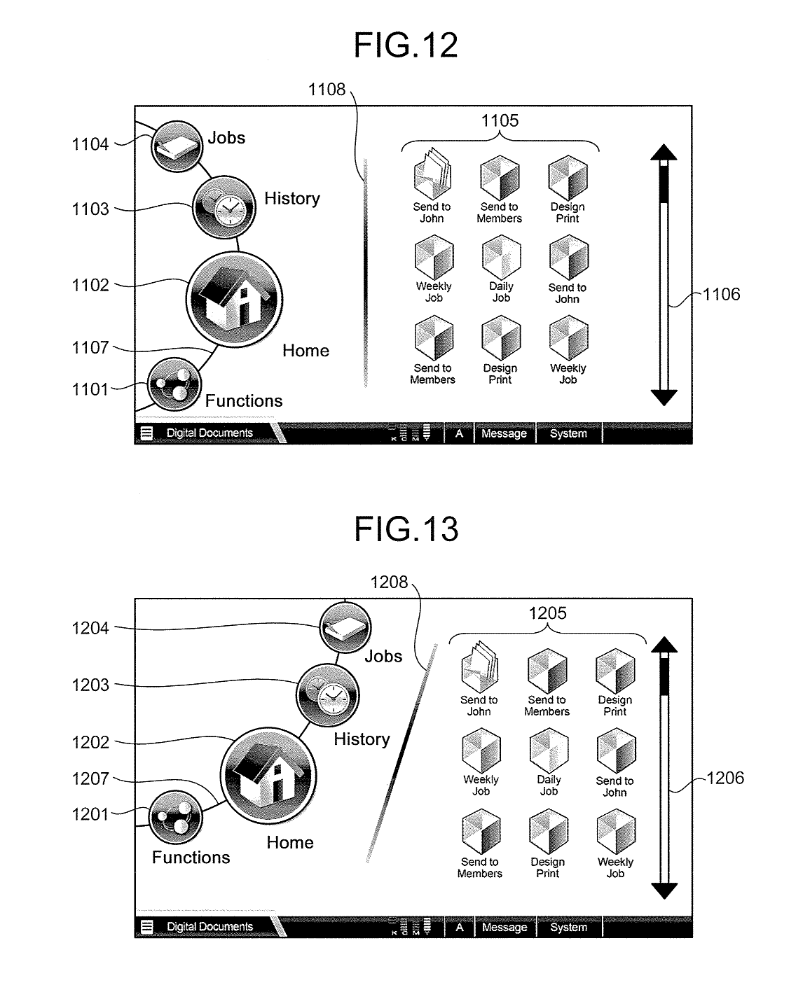

FIG. 12 is a schematic drawing of one example of the Home screen, which is a selection screen. As depicted in FIG. 12, the Home screen displayed on the liquid-crystal touch panel 220 has disposed thereon a solid-line linear image 1107 in an arc shape on the left side of the screen. On this linear image 1107, menu icons 1101, 1102, 1103, and 1104 are disposed. With this, the menu icons 1101, 1102, 1103, and 1104 are displayed in an arc shape. With the “Home” menu icon 1102 being displayed at the defined position as being enlarged compared with the other menu icons, it is indicated that the “Home” menu icon 1102 has been selected.

The defined position in the present embodiment is, as a position indicating that the menu icon has been selected, a position on the left of the screen in FIG. 12, slightly lower from the center, and second from the menu icon at the lower end. The display processing unit 101 causes the selected menu icon to be changed so that the selected menu icon is disposed at this defined position even when any of the menu icons is selected. Also, the display processing unit 101 changes the menu icons other than the selected menu icon that are displayed on the liquid-crystal touch panel 220 while keeping a positional relation with the selected menu icon. That is, a change is made along an arc-shaped linear image 1107 while the arrangement order of the menu icons is kept. As with the first and second embodiments, the linear image 1107 is an image of an arc-shaped curve indicating positions where a plurality of menu icons are disposed in an arc shape.

Also, on the Home screen, disposed on the right side of the menu icons 1101, 1102, 1103, and 1104 is a solid-line boundary image 1108, and disposed further on the right side is a group of sub-menu icons 1105 in a lattice shape, the group including sub-menu icons and setting icons corresponding to the “Home” menu icon. Here, as with the first and second embodiments, the boundary image 1108 is a straight-line image indicating a boundary between the menu icons and the sub-menu icons and setting icons.

On the right side of the group of sub-menu icons 1105, a scroll bar 1106 is displayed, thereby allowing sub-menu icons and setting icons that have not yet been able to be displayed on the liquid-crystal touch panel 220 to be displayed by scrolling.

In this manner, in the third embodiment, a selection screen having a plurality of menu icons disposed in an arc shape is displayed and, if a selection of a menu icon has been accepted from the user, a selection screen after change is displayed on the liquid-crystal touch panel 220, the selection screen after change obtained by enlarging the selected menu icon and changing to the defined position and changing the other displayed menu icons to be an arc shape while keeping a positional relation with the selected menu icon. On the right side of the selected menu icon, sub-menu icons and setting icons corresponding to the selected menu icon are displayed. Therefore, with the menu icons being disposed and changed to be in an arc shape, the contents of the menu icons displayed on the selection screen can be easy to recognize, and the position of a desired menu icon can be easily grasped. Also, with the sub-menu icons and setting icons corresponding to the selected menu icon being disposed in a lattice shape, operability of the process of setting various items can be improved.

In the first and second embodiments, the display processing unit 101 performs a vertical display in which the menu icons are disposed on an upper portion and the sub-menu icons and others are disposed below the menu icons. Alternatively, with the menu icons being disposed on an upper-left side and the sub-menu icons and others being disposed on a lower-right side by the display processing unit 101, a tilted display may be possible. Here, the configuration of the fourth embodiment is similar to the first embodiment except for the arrangement of the menu icons and the sub-menu icons and others, and therefore is not further explained herein.

FIG. 13 is a schematic drawing of one example of the Home screen, which is a selection screen. As depicted in FIG. 13, the Home screen displayed on the liquid-crystal touch panel 220 has disposed thereon a solid-line linear image 1207 in an arc shape on the left side of the screen. On this linear image 1207, menu icons 1201, 1202, 1203, and 1204 are disposed. With this, the menu icons 1201, 1202, 1203, and 1204 are displayed in an arc shape on the left side of the screen. With the “Home” menu icon 1202 being displayed at the defined position as being enlarged compared with the other menu icons, it is indicated that the “Home” menu icon 1202 has been selected.

The defined position in the present embodiment is, as a position indicating that the menu icon has been selected, a position on the left of the screen in FIG. 13, slightly lower from the center, and second from the menu icon at the lower end. The display processing unit 101 causes the selected menu icon to be changed so that the selected menu icon is disposed at this defined position even when any of the menu icons is selected. Also, the display processing unit 101 changes the menu icons other than the selected menu icon that are displayed on the liquid-crystal touch panel 220 while keeping a positional relation with the selected menu icon. That is, a change is made along an arc-shaped linear image 1207 while the arrangement order of the menu icons is kept. As with the first and second embodiments, the linear image 1207 is an image of an arc-shaped curve indicating positions where a plurality of menu icons are disposed in an arc shape.

Also, on the Home screen, disposed on the lower-right side of the menu icons 1201, 1202, 1203, and 1204 is a solid-line boundary image 1208, and disposed further on the lower-right side is a group of sub-menu icons 1205 in a lattice shape, the group including sub-menu icons and setting icons corresponding to the “Home” menu icon. As with the first and second embodiments, the boundary image 1208 is a straight-line image indicating a boundary between the menu icons and the sub-menu icons and setting icons.

On the right side of the group of sub-menu icons 1205, a scroll bar 1206 is displayed, thereby allowing sub-menu icons and setting icons that have not yet been able to be displayed on the liquid-crystal touch panel 220 to be displayed by scrolling.

In this manner, in the fourth embodiment, a selection screen having a plurality of menu icons disposed in an arc shape is displayed and, if a selection of a menu icon has been accepted from the user, a selection screen after change is displayed on the liquid-crystal touch panel 220, the selection screen after change obtained by enlarging the selected menu icon and changing to the defined position and changing the other displayed menu icons to be an arc shape while keeping a positional relation with the selected menu icon. On the lower-right side of the selected menu icon, sub-menu icons and setting icons corresponding to the selected menu icon are displayed. Therefore, with the menu icons being disposed and changed to be in an arc shape, the contents of the menu icons displayed on the selection screen can be easy to recognize, and the position of a desired menu icon can be easily grasped. Also, with the sub-menu icons and setting icons corresponding to the selected menu icon being disposed in a lattice shape, operability of the process of setting various items can be improved.

In the first and second embodiments, the display processing unit 101 performs a vertical display in which the menu icons are disposed on an upper portion and the sub-menu icons and others are disposed below the menu icons. Alternatively, a display area for the menu icons (hereinafter, “menu-icon area”) and a display area for the sub-menu icons and others (hereinafter, “sub-menu-icon area”) are configured as separate screens, with the screen of the menu-icon area being disposed on the rear side of the selection screen and the screen of the sub-menu-icon area being disposed so as to be superposed on the menu-icon area, the menu-icon area and the sub-menu-icon area may be displayed in a superposed manner on the front and the rear. Here, the fifth embodiment is similar to the first embodiment except for the arrangement of the menu icons and the sub-menu icons and others, and therefore is not further explained herein.

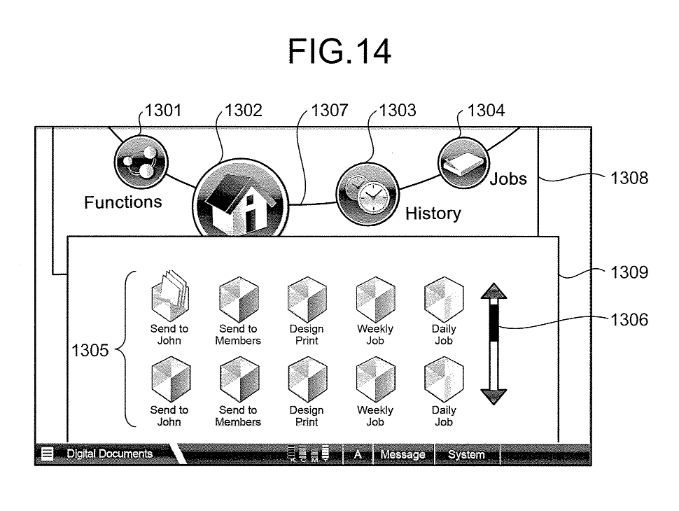

FIG. 14 is a schematic drawing of one example of the Home screen, which is a selection screen. As depicted in FIG. 14, in the Home screen displayed on the liquid-crystal touch panel 220, a menu-icon area 1308 and a sub-menu-icon area 1309 are displayed in a superposed manner with the menu-icon area 1308 on the rear side. The menu-icon area 1308 has disposed thereon a solid-line linear image 1307 in an arc shape. On this linear image 1307, menu icons 1301, 1302, 1303, and 1304 are disposed. With this, the menu icons 1301, 1302, 1303, and 1304 are displayed in an arc shape on the upper and rear side of the screen. With the “Home” menu icon 1302 being displayed at the defined position as being enlarged compared with the other menu icons, it is indicated that the “Home” menu icon 1302 has been selected. The sub-menu-icon area 1309 has displayed thereon sub-menu icons and a scroll bar 1306.

The defined position in the present embodiment is, as a position indicating that the menu icon has been selected, a position on an upper portion of the screen in FIG. 14, slightly left from the center, and second from the menu icon at the lower end. The display processing unit 101 causes the selected menu icon to be changed so that the selected menu icon is disposed at this defined position even when any of the menu icons is selected. Also, the display processing unit 101 changes the menu icons other than the selected menu icon that are displayed on the liquid-crystal touch panel 220 while keeping a positional relation with the selected menu icon. That is, a change is made along an arc-shaped linear image 1307 while the arrangement order of the menu icons is kept. As with the first and second embodiments, the linear image 1307 is an image of an arc-shaped curve indicating positions where a plurality of menu icons are disposed in an arc shape.

Also, in the sub-menu-icon area 1309 on the Home screen, a group of sub-menu icons 1305 in a lattice shape is disposed for display, the group including sub-menu icons and setting icons corresponding to the “Home” menu icon. The group is displayed so as to be partly superposed with the menu icons 1302 in the menu-icon area 1308 on the front side of a lower portion of the screen. On the right side of the group of sub-menu icons 1305, a scroll bar 1306 is displayed, thereby allowing sub-menu icons and setting icons that have not yet been able to be displayed on the liquid-crystal touch panel 220 to be displayed by scrolling.

In this manner, in the fifth embodiment, a selection screen having a plurality of menu icons disposed in an arc shape is displayed and, if a selection of a menu icon has been accepted from the user, a selection screen after change is displayed on the liquid-crystal touch panel 220, the selection screen after change obtained by enlarging the selected menu icon and changing to the defined position in the menu-icon area 1308 and changing the other displayed menu icons to be an arc shape while keeping a positional relation with the selected menu icon. On the front side of the menu-icon area 1308 having displayed thereon the selected menu icon, the sub-menu-icon area 1309 having disposed thereon sub-menu icons and setting icons corresponding to the selected menu icon is displayed so as to be superposed on the menu-icon area 1308. Therefore, with the contents of the menu icons being disposed and changed to be in an arc shape, the contents of the menu icons displayed in the menu-icon area 1308 on the selection screen can be easy to recognize, and the position of a desired menu icon can be easily grasped. Also, with the sub-menu icons and setting icons corresponding to the selected menu icon being disposed in a lattice shape in the sub-menu-icon area 1309 for display, operability of the process of setting various items can be improved.

In the first to fifth embodiments, the display processing unit 101 causes the menu icons to be disposed and displayed on the linear image. Alternatively, the menu icons may be disposed and displayed near the linear image, for example, outside of the arc shape of the linear image.

In the first to fifth embodiments, when a selection of a menu icon is accepted, the display processing unit 101 once causes the switching screen to be displayed, and then causes a selection screen after change to be displayed, the selection screen after change obtained by changing the menu icon to the predetermined position. With this, the menu icons are viewed by the user as being rotated and moved in an arc shape. Alternatively, the display processing unit 101 may actually cause the menu icons to be rotated and moved in an arc shape for display. In this case, a rotation can be made in a direction of a shortest distance toward the selected menu icon, or a rotation is always in a clockwise or counterclockwise direction. Alternatively, screens representing the course until a selected menu icon is changed to the predetermined position may be stored in advance in the storage unit 104 and, when a menu icon is selected, these screens may be successively displayed, thereby causing the menu icon to be displayed as being moved in an arc shape.

Also, in the first to fifth embodiments, when the selection screen is displayed by the display processing unit 101, a selection screen having the menu icons, the sub-menu icons, and other disposed on the background screen is generated, and the generated selection screen is displayed on the liquid-crystal touch panel 220. Such a process is not meant to be restrictive as long as a selection screen representing the menu icons are rotated can be displayed. For example, images of selection screens different in arrangement of the menu icons are stored and prepared in advance in the storage unit 104 as many as the number of menu icons and, when a menu icon is selected by the user, the display processing unit 101 reads a selection screen in which the selected menu icon is enlarged and disposed at the defined position and causes the read selection screen to be displayed on the liquid-crystal touch panel 220, without disposing various icons on the background screen. In this case, since a process of disposing the icons on the background screen is not required, the display process can be performed quickly.

Also, in the first to fifth embodiments, the display processing unit 101 causes the selected menu icons to be enlarged and displayed at the defined position. This is not meant to be restrictive. Alternatively, the selected menu icon may be changed to the defined position without being enlarged.

In the first to fifth embodiments, the display processing unit 101 causes the menu icons to form a circular shape, in which illustrations of the menu items are added for identification of the menu items. This is not meant to be restrictive, and other shape and illustrations may be used as menu icons. For example, menu icons in various shapes, such as stars and diamonds, menu icons made of various textures, such as wood, fabric, and metal, and menu icons of various colors, such as red, blue, and yellow can be used for identification of the menu items.

In the first to fifth embodiments, an example of application of the display processing device to the MFP has been explained. The present invention is not restricted to this, however, and can be applied to anything as long as predetermined information can be displayed. For example, the present invention can be applied to, for example, a copier for printing data, a facsimile device, a personal computer (PC), and a car navigation system for displaying a present point of a vehicle and displaying a route to a specified destination, as a display processing device.

When the present invention is applied to such a copier, facsimile device, car navigation system, or the like, menus and others displayed on a screen for setting various functions are displayed in an arc shape as with the present embodiments, and a selection or the like can be accepted from a liquid-crystal touch panel. Also, when the present invention is applied to a PC and others not provided with a displaying unit for an input from a display screen, such as a liquid-crystal touch panel, as with the present embodiments, menus and others displayed on a screen for setting various functions are displayed in an arc shape, and a selection or the like can be accepted from an input device, such as a mouse.

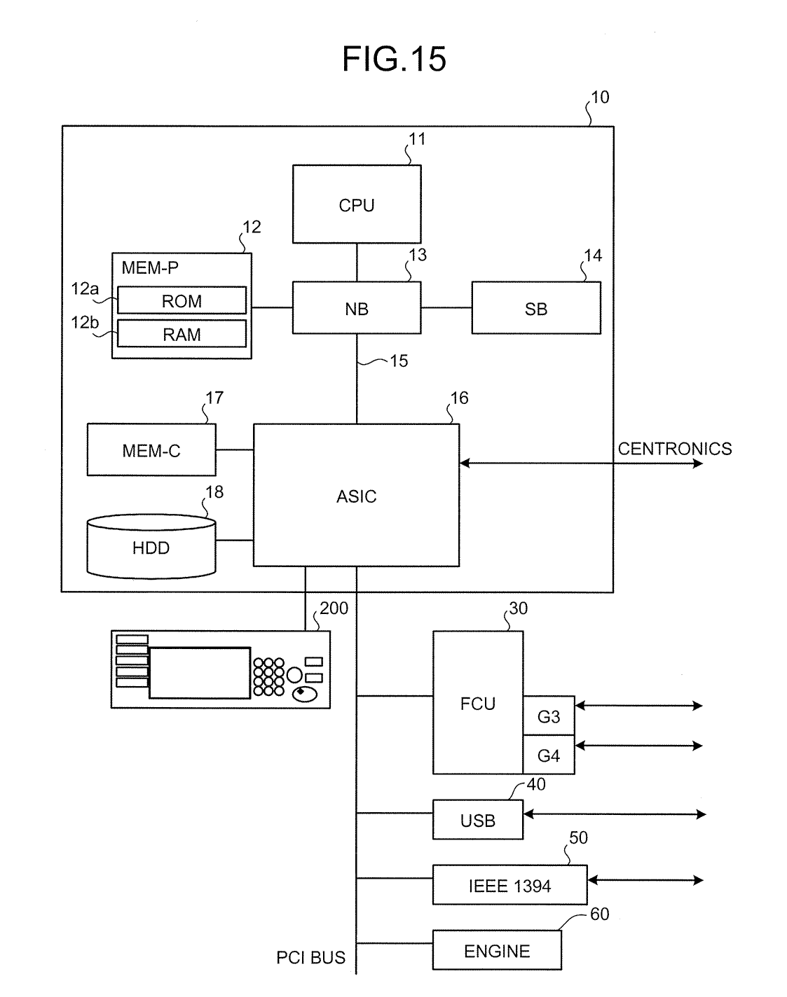

FIG. 15 is a block drawing of hardware configuration of an MFP according to the first and second embodiments. As depicted in the drawing, this MFP 100 has a configuration in which a controller 10 and an engine unit (Engine) 60 are connected via a Peripheral Component Interconnect (PCI) bus. The controller 10 is a controller that controls the entire MFP 100, rendering, communication, and inputs from the operation panel 200. The engine unit 60 is, for example, a printer engine connectable to the PCI bus. Examples of the engine units 60 are, for example, a monochrome plotter, a one-drum color plotter, a four-drum color plotter, a scanner, or a facsimile unit. Here, this engine unit 60 includes, in addition to a so-called engine unit, such as a plotter, an image processing unit for error diffusion or gamma transformation.

The controller 10 includes a Central Processing Unit (CPU) 11, a system memory (MEM-P) 12, a northbridge (NB) 13, a southbridge (SB) 14, a local memory (MEM-C) 17, an Application Specific Integrated Circuit (ASIC) 16, and a hard disk drive (HDD) 18, with the NB 13 and the ASIC 16 being connected via an Accelerated Graphics Port (AGP) bus 15. Also, the MEM-P 12 further includes a Read Only Memory (ROM) 12a and a Random Access Memory (RAM) 12b.

The CPU 11 performs the entire control over the MFP 100, has a chip set formed of the NB 13, the MEM-P 12, and the SB 14. Via this chip set, the CPU 11 is connected to other devices.

The NB 13 is a bridge for connection of the CPU 11 with the MEM-P 12, the SB 14, and the AGP 15, and has a memory controller that control read and write with respect to the MEM-P 12, a PCI master, and an AGP target.

The MEM-P 12 is a system memory for use as a memory for storing programs and data, a memory for developing the programs and data, or a rendering memory for printers, and includes the ROM 12a and the RAM 12b. The ROM 12a is a read-only memory for use as a memory for storing programs and data, whilst the RAM 12b is a writable and readable memory for use as a rendering memory for printers.

The SB 14 is a bridge for connection between the NB 13 and PCI devices and peripheral devices. This SB 14 is connected to the NB 13 via the PCI bus. To this PCI bus, the network interface (I/F) unit is connected, for example.

The ASIC 16 is an integrated circuit (IC) dedicated for image processing having hardware components for image processing, serving as a bridge connecting the AGP 15, the PCI bus, the HDD 18, and the MEM-C 17. This ASIC 16 includes a PCI target and an AGP master, an arbiter (ARB), which is a core of the ASIC 16, a memory controller that controls the MEM-C 17, a plurality of Direct Memory Access Controllers (DMAC) for rotating image data with hardware logic, and a PCI unit for data transfer via the PCI bus with the engine unit 60. To this ASIC 16, a Fax Control Unit (FCU) 30, a Universal Serial Bus (USB) 40, and the Institute of Electrical and Electronic Engineers 1394 (IEEE 1394) interface 50 are connected via PCI bus.

The MEM-C 17 is a local memory for use as an image buffer for copy or a code buffer. The HDD 18 is a storage for storing image data, programs, font data, and forms.

The AGP 15 is a bus interface for a graphics accelerator card suggested for increasing speed of graphic processing and, by directly accessing the MEM-P 12 with a high throughput, increase the speed of the graphic accelerator card.

Here, a display processing program to be executed on the display processing device described in the embodiments is provided as being incorporated in advance in a ROM or the like.

Also, the display processing program to be executed on the display processing device in the embodiments explained above may be configured to be recorded as a file in an installable or executable format on a computer-readable recording medium for provision, such as a Compact-Disk Read-Only Memory (CD-ROM), a flexible disk (FD), a Compact-Disk Recordable (CD-R), or a Digital Versatile Disk (DVD).

Furthermore, the display processing program to be executed on the display processing device in the present embodiment may be configured to be stored on a computer connected to a network, such as the Internet, and is downloaded via the network for provision. Also, the display processing program to be executed on the display processing device in the present embodiment may be configured to be provided or distributed via a network, such as the Internet.

The display processing program to be executed on the display processing device in the present embodiment has a module configuration including each unit explained above (the display processing unit, the selection accepting unit, the execution processing unit, and the user authenticating unit). As actual hardware, the CPU (processor) reads the display processing program from the ROM for execution, thereby loading each unit onto a main storage device and generating each unit on the main storage device.

According to an aspect of the present invention, the upper-level-item symbols are disposed in an arc shape for display on the displaying unit and, upon acceptance of a selection of an upper-level-item symbol, a selection screen after change is displayed on the displaying unit, the selection screen after change being obtained by changing the selected upper-level-item symbol to a defined position indicative of being selected and changing other displayed upper-level-item symbols while keeping a positional relation with the selected upper-level-item symbol. With this, an effect can be achieved such that the contents of the setting items are easy to recognize and the position of a desired setting item can be easily grasped.

Moreover, lower-level-item symbols corresponding to the selected upper-level-item symbol are disposed in a lattice shape for display. With this, an effect can be achieved such that operability of various setting operations and others can be improved.

Furthermore, the lower-level-item symbols corresponding to the upper-level-item symbols other than the selected upper-level-item symbols are reduced for display. With this, an effect can be achieved such that the contents of the lower-level setting items in the unselected upper-level setting items can be easily grasped, thereby further improving operability.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display processing device comprising:
a display processing unit that displays on a displaying unit a selection screen having disposed thereon in an arc shape a plurality of upper-level-item symbols that correspond to a plurality of upper-level setting items for instruction of selection of the upper-level setting items; and
a selection accepting unit that accepts a selection of an upper-level-item symbol from among the upper-level-item symbols by a user, wherein
the display processing unit displays on the displaying unit a selection screen after change in which the selected upper-level-item symbol is arranged at a predetermined position indicative of being selected and in which non-selected upper-level-item symbol are arranged so as to maintain a positional relation with the selected upper-level-item symbol.

2. The display processing device according to claim 1, wherein, on the selection screen after change, the selected upper-level-item symbol is displayed in a bigger size than the non-selected upper-level-item symbols.

3. The display processing device according to claim 1, wherein a lower-level-item symbol that corresponds to a lower-level setting item of the upper-level setting item is displayed on the selection screen after change.

4. The display processing device according to claim 3, wherein a plurality of the lower-level-item symbols is displayed in a lattice shape on the selection screen after change.

5. The display processing device according to claim 4, wherein the lower-level-item symbols are displayed below the upper-level-item symbols.

6. The display processing device according to claim 1, wherein the display processing unit causes the selection screen after change to be displayed on the displaying unit, the selection screen after change being obtained by displaying a switching screen indicative of a state where the upper-level-item symbols are virtually rotated, and then changing the selected upper-level-item symbol to the defined position and changing the other displayed upper-level-item symbols while keeping the positional relation with the selected upper-level-item symbol.

7. The display processing device according to claim 1, wherein the non-selected upper-level-item symbols are not displayed and new upper-level-item symbols are displayed on the selection screen.

8. The display processing device according to claim 1, wherein a linear image representing the arc shape indicating positions of disposing the upper-level-item symbols, and the upper-level-item symbols on or near the linear image are displayed on the selection screen after change.

9. The display processing device according to claim 1, wherein
the selection accepting unit accepts successive instruction operations on or near the upper-level-item symbols by the user, and
when the successive instruction operations are accepted by the selection accepting unit, the display processing unit causes the selection screen after change to be successively switched and displayed on the displaying unit.

10. The display processing device according to claim 3, wherein a lower-level-item symbol corresponding to the non-selected upper-level-item symbol is displayed in a smaller size on the selection screen after change.

11. The display processing device according to claim 10, further comprising a storage unit that stores therein the upper-level-item symbols and a background screen having an area where the upper-level-item symbols can be disposed, wherein
the display processing unit reads the upper-level-item symbols and the background screen from the storage unit, generates a selection screen having the upper-level-item symbols disposed in an arc shape on the background screen, and displays generated selection screen on the displaying unit.

12. The display processing device according to claim 11, wherein the display processing unit enlarges the selected upper-level-item symbol when generating the selection screen after change.

13. The display processing device according to claim 11, wherein
the storage unit stores therein a lower-level-item symbol in association with at least one of the upper-level-item symbols, and
the display processing unit reads a lower-level-item symbol corresponding to the selected upper-level-item symbol from the storage unit, generates the selection screen after change having the read lower-level-item symbol disposed on the background screen, and displays generated selection screen after change on the displaying unit.

14. The display processing device according to claim 13, wherein the display processing unit generates the selection screen after change having a plurality of the lower-level-item symbols disposed in a lattice shape on the background screen, and displays generated selection screen after change on the displaying unit.

15. The display processing device according to claim 13, wherein the display processing unit generates the selection screen after change having the upper-level-item symbols disposed on an upper portion of the background screen and having the lower-level-item symbols disposed below the upper-level-item symbols, and displays generated selection screen after change on the displaying unit.

16. The display processing device according to claim 11, wherein
the storage unit stores therein the switching screen,
upon acceptance of the selection of the upper-level-item symbol, the display processing unit reads the switching screen from the storage unit for display, then reads the upper-level-item symbols and the background screen from the storage unit, generates a selection screen having the read upper-level-item symbols disposed in an arc shape on the background screen, and displays generated selection screen on the displaying unit.

17. The display processing device according to claim 11, wherein the display processing unit generates the selection screen after change having disposed on the background screen a linear image representing a curve image in an arc shape indicating positions of disposing the upper-level-item symbols and having disposed the upper-level-item symbols on or near the linear image, and displays generated selection screen after change on the displaying unit.

18. The display processing device according to claim 11, wherein upon acceptance of the selection of the upper-level-item symbol, the display processing unit reads the background screen from the storage unit, generates the selection screen after change by newly disposing on the background screen any of the upper-level-item symbols that are not displayed on the displaying unit and deleing any of the upper-level-item symbols that have been displayed on the displaying unit, and displays generated selection screen after change on the displaying unit.

19. A display method comprising:
first displaying including displaying on a displaying unit a selection screen having disposed thereon in an arc shape a plurality of upper-level-item symbols that correspond to a plurality of upper-level setting items for instruction of selection of the upper-level setting items;
accepting a selection of an upper-level-item symbol from among the upper-level-item symbols by a user; and
second displaying including displaying on the displaying unit a selection screen after change in which the selected upper-level-item symbol is arranged at a predetermined position indicative of being selected and in which non-selected upper-level-item symbol are arranged so as to maintain a positional relation with the selected upper-level-item symbol.

20. A computer program product containing a computer program that causes a computer to implement a displaying method, the computer program causing the computer to execute:
first displaying including displaying on a displaying unit a selection screen having disposed thereon in an arc shape a plurality of upper-level-item symbols that correspond to a plurality of upper-level setting items for instruction of selection of the upper-level setting items;
accepting a selection of an upper-level-item symbol from among the upper-level-item symbols by a user; and
second displaying including displaying on the displaying unit a selection screen after change in which the selected upper-level-item symbol is arranged at a predetermined position indicative of being selected and in which non-selected upper-level-item symbol are arranged so as to maintain a positional relation with the selected upper-level-item symbol.
